(19) United States
(12) Patent Application Publication
(10) Pub. No.: US 2021/0081665 A1
(43) Pub. Date: Mar. 18, 2021

(54) MEASURING SIMILARITY OF NUMERIC CONCEPT VALUES WITHIN A CORPUS

(71) Applicant: INTERNATIONAL BUSINESS MACHINES CORPORATION, Armonk, NY (US)

(72) Inventors: Kyle G. Christianson, Rochester, MN (US); Eric L. Erpenbach, Oronoco, MN (US); Katherine A. Kairis, Pittsburgh, PA (US); Tyra Alexa Mccoy, Ellenwood, GA (US)

(21) Appl. No.: 16/573,164

(22) Filed: Sep. 17, 2019

(51) Int. Cl. G06K 9/00; G06K 9/62; G06F 17/18; G06F 17/27

(52) U.S. Cl. CPC G06K 9/00483; G06F 17/2705; G06F 17/18; G06K 9/6215

(57) ABSTRACT

A method, computer system, and computer program product for measuring similarity of numeric concept values within a corpus are provided. The embodiment may include retrieving numerical values associated with a concept in a corpus. The embodiment may also include converting the numerical values to a standard unit. The embodiment may further include computing a distribution value of the converted numerical values. The embodiment may also include determining a tolerance value based on the distribution value, wherein the tolerance value is the maximum allowable distance between two numerical values. The embodiment may further include determining a distance function based on the determined tolerance value, wherein the distance function is defined by dividing a difference between two numerical values by the determined tolerance value. The embodiment may also include computing a similarity distance between the numerical values.

### BACKGROUND

The present invention relates, generally, to the field of computing, and more particularly to document similarity analysis.

Document similarity analysis generally involves extracting a document vector to represent the documents as a whole using a statistical approach. The vector is made from the statistically most important words contained in the document. Vocabularies contained in a document may also be analyzed to obtain a document vector when a specific topic is the main factor in comparing two different documents. The importance of vocabularies or terms is often weighted in accordance with its frequencies in a data set as a whole. After document vectors are extracted, the information is stored as metadata in a database such that similarity analysis may perform a comparison of the vectors of different documents. Cosine similarity is a commonly used similarity measure for real-valued vectors in information retrieval to score the similarity of different documents. Today, in machine learning, common kernel functions, such as the radial basis function (RBF) kernel, can be commonly used in support vector machine classification.

### SUMMARY

According to one embodiment, a method, computer system, and computer program product for measuring similarity of numeric concept values within a corpus are provided. The embodiment may include retrieving numerical values associated with a concept in a corpus. The embodiment may also include converting the numerical values to a standard unit. The embodiment may further include computing a distribution value of the converted numerical values. The embodiment may also include determining a tolerance value based on the distribution value, wherein the tolerance value is the maximum allowable distance between two numerical values. The embodiment may further include determining a distance function based on the determined tolerance value, wherein the distance function is defined by dividing a difference between two numerical values by the determined tolerance value. The embodiment may also include computing a similarity distance between the numerical values.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a numeric concept value similarity determination process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to document similarity analysis. The following described exemplary embodiments provide a system, method, and program product to determine the similarity of two numerical values within a corpus based on calculation of a normalized distance between two values which may be regarded as the inverse of similarity. Therefore, the present embodiment has the capacity to improve the technical field of document similarity analysis systems by focusing on document concepts which have associated numeric data or values and calculating similarity measures based on such numeric values in order to compare similarity of documents that involve various numeric values in the content.

As previously described, document similarity analysis generally involves extracting a document vector to represent the documents as a whole using a statistical approach. The vector is made from the statistically most important words contained in the document. Vocabularies contained in a document may also be analyzed to obtain a document vector when a specific topic is the main factor in comparing two different documents. The importance of vocabularies or terms is often weighted in accordance with its frequencies in a data set as a whole. After document vectors are extracted, the information is stored as metadata in a database such that similarity analysis may perform a comparison of the vectors of different documents. Cosine similarity is a commonly used similarity measure for real-valued vectors in information retrieval to score the similarity of different documents. Today, in machine learning, common kernel functions, such as the radial basis function (RBF) kernel, can be commonly used in support vector machine classification.

Comparing the concepts that occur in two documents may be a useful method to determine the similarity between two documents within a corpus. Similarity measures can be used in document search, clustering, determining outliers, or determining novelty. While concept comparison is useful in measuring the similarity of two documents, documents often have additional information that can be leveraged to compute a similarity score. For example, some concepts have associated numeric values. Concept values are important in documents that involve time frames, drug dosages, monetary values, etc. For instance, two clinical trials that investigate the effects of the same drug would likely be assigned a high degree of similarity with a solely concept-based similarity algorithm, even if the dosages used in the two studies differ. In this example, an algorithm that incorporates concept numerical values would appropriately assign a smaller degree of similarity between the two trials. Conversely, depending on the distribution of dosages for this drug, the dosages in said trials, and therefore the two trials overall, may still be considered very similar. As such, it may be advantageous to, among other things, implement a system capable of extracting the numeric values associated with the concepts appearing in a corpus and determining a distance function for each concept using the extracted values. The computed distance functions would determine the similarity of two numeric values associated with the same concept. When comparing documents with a large amount of numeric data, such as financial reports, incorporating similarity measures between concept values would be particularly beneficial. In such cases, an algorithm that only considers concept occurrence may overestimate the similarity of two documents, which would adversely impact the results of clustering, document searches, and novelty determination. Incorporating numerical similarity into the algorithm could produce more accurate similarity scores, and therefore improve the results for any procedures that rely on document similarity measures.

According to one embodiment, the present invention may compute the distribution of values associated with specific concepts in a corpus. In at least one other embodiment, the present invention may also utilize a concept's value distribution to determine a tolerance range. The present invention may further utilize a concept's tolerance range to create a difference function to compare two concept values.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for measuring the similarity of documents in a corpus based on computation of the distance between two concept values using a distance function.

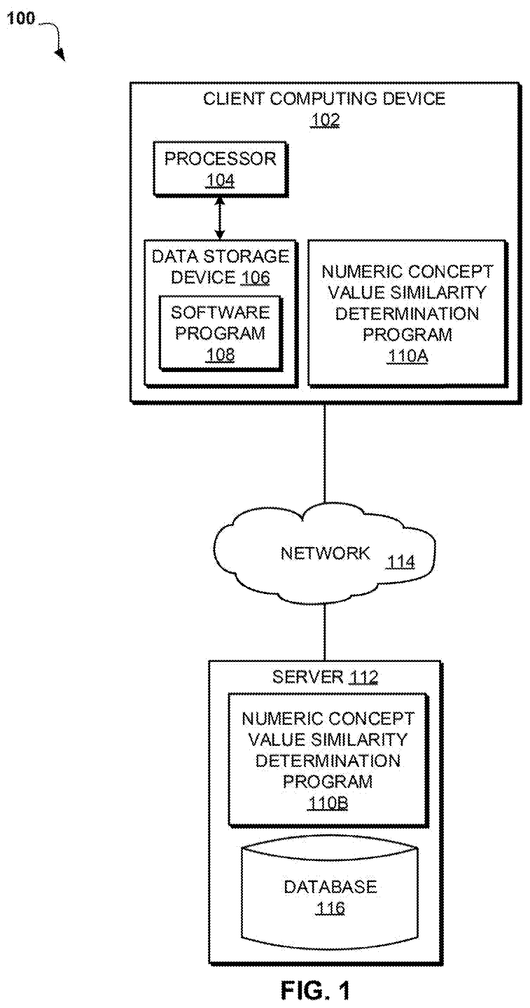

Referring to FIG. 1, an exemplary networked computer environment 100 is depicted according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

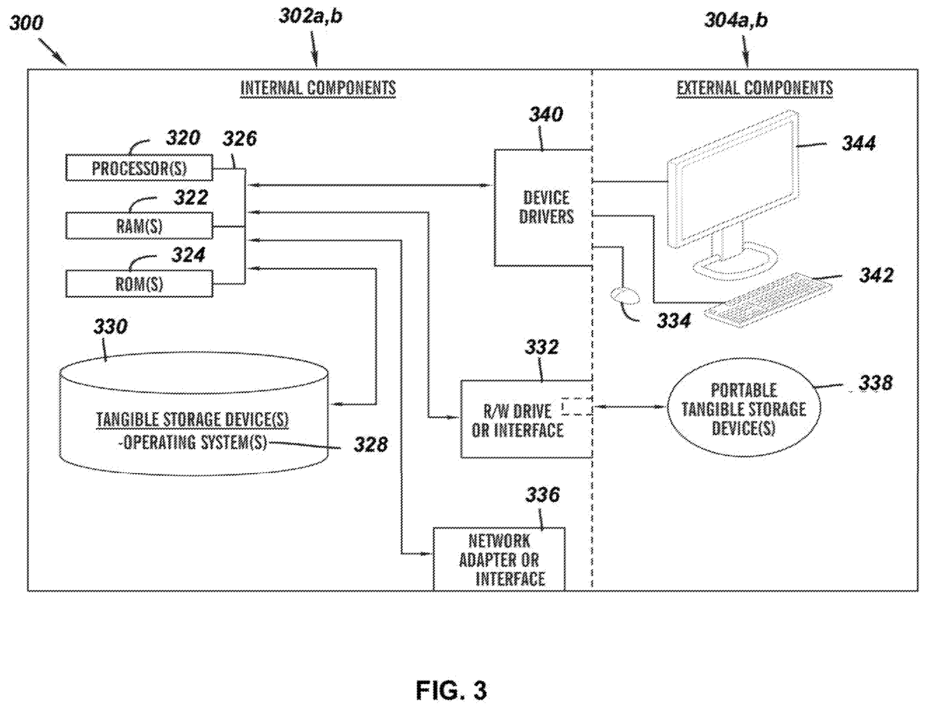

Client computing device 102 may include a processor 104 and a data storage device 106 that is enabled to host and run a software program 108 and a numeric concept value similarity determination program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a numeric concept value similarity determination program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

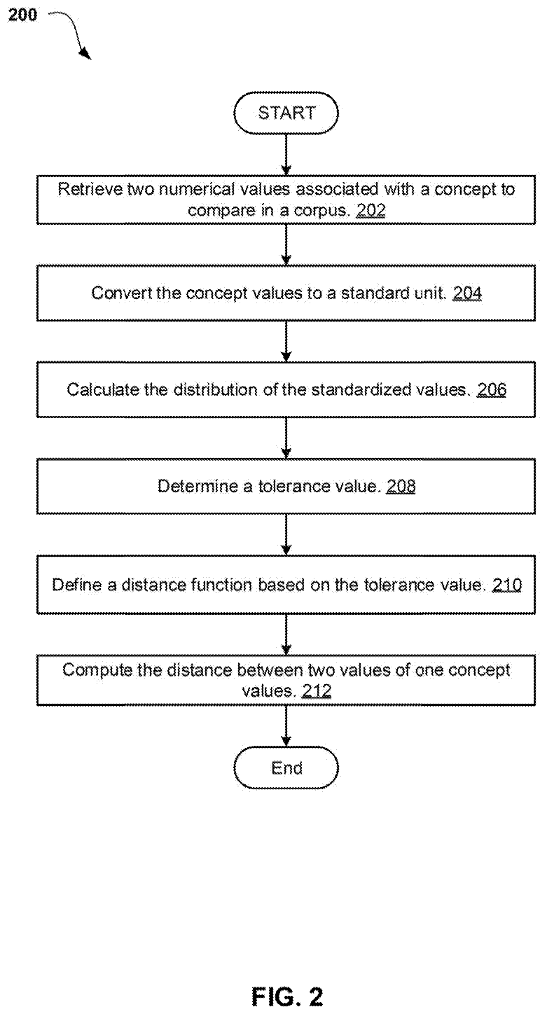

According to the present embodiment, the numeric concept value similarity determination program 110A, 110B may be a program capable of calculating a distribution for numerical concept values and computing the distance between two concept values using a defined distance function. The numeric concept value similarity determination process is explained in further detail below with respect to FIG. 2.

Referring to FIG. 2, an operational flowchart illustrating a numeric concept value similarity determination process 200 is depicted according to at least one embodiment. At 202, the numeric concept value similarity determination program 110A, 110B retrieves the numeric values associated with concepts occurring in a corpus. According to one embodiment, the numeric concept value similarity determination program 110A, 110B may retrieve all of the numerical values associated with a concept in a corpus during a preprocessing step. For example, if a user wants to compare numerical values associated with blood pressure in a corpus, the numeric concept value similarity determination program 110A, 110B may retrieve all of the numerical values associated with blood pressure in the corpus.

At 204, the numeric concept value similarity determination program 110A, 110B converts the concept values to a standard unit. According to one embodiment, the numeric concept value similarity determination program 110A, 110B may determine a standard unit for all of the values associated with a concept. For example, if documents discuss change in blood pressure measured in different time frames, the concept, “time frame” or “time” may refer to different time units, such as days, weeks, months, hours, etc. After retrieving the “time frame” values from the corpus, each value needs to be converted to a standard unit for the concept. In at least one other embodiment, a user may elect to select a standard unit and the numeric concept value similarity determination program 110A, 110B may convert value units to the selected standard unit. In the same example, if a user selects days as a standard unit for the concept, “time frame”, the numeric concept value similarity determination program 110A, 110B may covert values in weeks, months, hours or seconds to days.

At 206, the numeric concept value similarity determination program 110A, 110B calculates the distribution of a concept's standardized values. According to one embodiment, the numeric concept value similarity determination program 110A, 110B may calculate the distribution of the standardized values, such as median, average and standard deviation. In the above example, if the concept “time frame” relates to the following values associated with the concept in the corpus: 10 days, 2 weeks, 5 days, 1 month, 14 days, 72 hours, 7 days, 10 days, 1 week, 48 hours, 15 days, 7 days, 3 weeks, 20 days, 3 days, 5 days, 6 weeks, 20 days, 4 days, 5 days, these values may be converted to standardized values: 10 days, 14 days, 5 days, 30 days, 14 days, 3 days, 7 days, 10 days, 7 days, 2 days, 15 days, 7 days, 21 days, 20 days, 3 days, 5 days, 42 days, 20 days, 4 days, 5 days. Based on the above standardized values, the numeric concept value similarity determination program 110A, 110B may calculate: the median equals 8.5 days; the average equals 12.2 days; the standard deviation equals 10.0 days.

At 208, the numeric concept value similarity determination program 110A, 110B determines a tolerance value for the concept. According to one embodiment, the numeric concept value similarity determination program 110A, 110B may determine the maximum allowable distance between two values such that the values may be considered equivalent. In one embodiment, a tolerance value may be directly related to the previously calculated standard deviation. For example, a tolerance value may equal the standard deviation or half the standard deviation. In at least one other embodiment, a tolerance value may depend on the type of distribution such as normal distribution or skewed distribution, etc.

At 210, the numeric concept value similarity determination program 110A, 110B defines a distance function for a concept's values based on the tolerance value. According to one embodiment, the numeric concept value similarity determination program 110A, 110B may define a distance as follows: distance=Abs (Value1−Value2)/tolerance, where the tolerance is a fixed value, and value 1 and value 2 are the function's parameters. In the above example, if the standard deviation is selected as the tolerance value, the tolerance value is 10.0 days and Value1 and Value 2 may be any two values associated with the concept, “time frame”.

At 212, the numeric concept value similarity determination program 110A, 110B computes the distance between two values of one concept. According to one embodiment, the numeric concept value similarity determination program 110A, 110B may use the defined distance function to compute the distance between two concept values. The numeric concept value similarity determination program 110A, 110B may convert two values to a concept's standard unit first and apply the distance function to the two standardized values to compute the distance between the values. For example, if a user needs to compare two time frames 29 days and 31 days, the defined function computes Abs(29−31)/10 and obtains a distance value of 0.2. If two values are 5 weeks and 10 days, the numeric concept value similarity determination program 110A, 110B converts the values to 10 days and 35 days. The distance value is then Abs(35−10)/10, which equals 2.5. In this example, the lower distance value of 0.2 may mean higher similarity than the distance value of 2.5. In yet another embodiment, the numeric concept value similarity determination program 110A, 110B may compare values of two differing concepts if the concepts have the same hierarchical parent or child. For example, if there are three short documents—Document A, Document B, and Document C—that describe the dosages of antibiotics. Each document has one concept and an associated numerical value as follows:

Document A: [Penicillin=300 mg]
Document B: [Antibiotic=300 mg]
Document C: [Penicillin=500 mg]
If Document B is being compared to Documents A and C using an embodiment that ignores the hierarchical relationship between concepts, two concept values may only be compared if they are associated with the same concept. Using an embodiment that ignores the relationship between Penicillin and the antibiotic may impact the overall similarity measures of these documents. Specifically, a document similarity algorithm would likely consider Documents A and C equally similar to Document B. However, since Penicillin is an antibiotic—antibiotic and Penicillin have a parent-child relationship—it may be desirable to allow a comparison between the numeric values of these two related concepts, leading to results that indicate a greater degree of similarity between Documents B and A than between Documents B and C.

In at least one other embodiment, the numeric concept value similarity determination program 110A, 110B may compute a confidence score based on the number of values found in a corpus when computing distribution values and add to similarity measures. For example, if there are more available values related to the concept, “time frame” found in a corpus, distribution values such as median, average and standard deviation may obtain higher confidence scores. In the above example, if a user wants to calculate a distance function for antibiotic dosages, there may not be just one specific corpus that the user may need to use to calculate the distribution, tolerance value, and distance function. There may be many corpora that the user may possibly use, and the corpora may have different sizes. One corpus may have 250 values associated with antibiotic dosages, while a second corpus may only have 25 values. While the user may use either corpus to compute the distance function, the comparison results for each distance function may have different confidence values. The results of a distance function computed from the first corpus may have a higher confidence value than the one from the second corpus as the first corpus has a lot more occurrences of antibiotic dosages than the second corpus.

It may be appreciated that FIG. 2 provide only an illustration of one implementation and do not imply any limitations with regard to how different embodiments may be implemented. Many modifications to the depicted environments may be made based on design and implementation requirements. For example, in at least one embodiment, the numeric concept value similarity determination program 110A, 110B may compute and update real-time value of distribution and distance function as additional documents are added to a corpus.

FIG. 3 is a block diagram of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smartphone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the numeric concept value similarity determination program 110A in the client computing device 102 and the numeric concept value similarity determination program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes an R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the numeric concept value similarity determination program 110A, 110B can be stored on one or more of the respective portable computer-readable tangible storage devices 338, read via the respective R/W drive or interface 332 and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the numeric concept value similarity determination program 110A in the client computing device 102 and the numeric concept value similarity determination program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the numeric concept value similarity determination program 110A in the client computing device 102 and the numeric concept value similarity determination program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

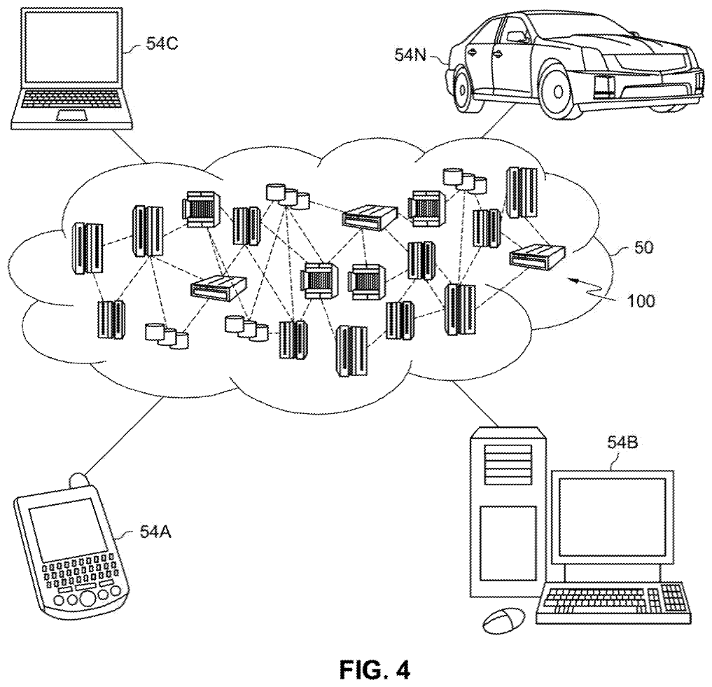

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

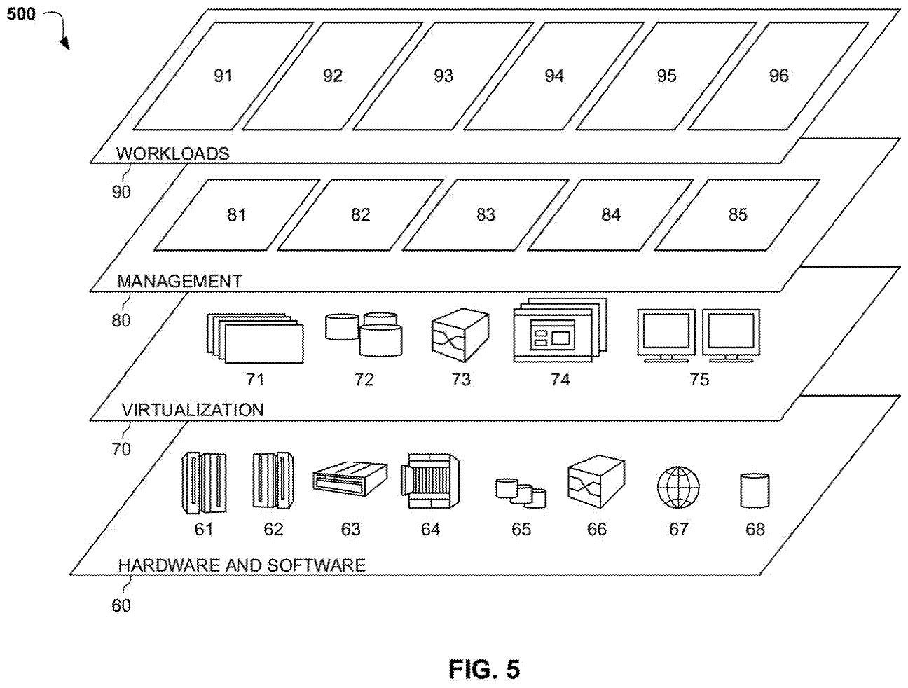

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and numeric concept value similarity determination 96. Numeric concept value similarity determination 96 may relate to defining a distance function to compute a distance between two concept values within a corpus.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for measuring similarity of numeric concept values within a corpus, the method comprising:
retrieving numerical values associated with a concept in a corpus;
converting the numerical values to a standard unit;
computing a distribution value of the converted numerical values;
determining a tolerance value based on the distribution value, wherein the tolerance value is the maximum allowable distance between two numerical values;
determining a distance function based on the determined tolerance value, wherein the distance function is defined by dividing a difference between two numerical values by the determined tolerance value; and
computing a similarity distance between the numerical values.

2. The method of claim 1, wherein a distribution value comprises a distribution calculation, wherein the distribution calculation is selected from a group consisting of an average, a median, and a standard deviation.

3. The method of claim 1, further comprising:
determining a confidence score based on a number of numerical values associated with a concept when determining the similarity distance.

4. The method of claim 1, further comprising:
comparing values of two different concepts when the concepts have a same hierarchical parent in a corpus.

5. The method of claim 1, further comprising:
updating a real-time value of the distribution value and the distance function as new documents are added to the corpus.

6. The method of claim 1, further comprising:
allowing a user to select a standard unit to which the numerical values are converted.

7. The method of claim 1, wherein the tolerance value is directly related to a standard deviation of the numerical values.

8. A computer system for measuring similarity of numeric concept values within a corpus, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
retrieving numerical values associated with a concept in a corpus;
converting the numerical values to a standard unit;
computing a distribution value of the converted numerical values;
determining a tolerance value based on the distribution value, wherein the tolerance value is the maximum allowable distance between two numerical values;
determining a distance function based on the determined tolerance value, wherein the distance function is defined by dividing a difference between two numerical values by the determined tolerance value; and
computing a similarity distance between the numerical values.

9. The computer system of claim 8, wherein a distribution value comprises a distribution calculation, wherein the distribution calculation is selected from a group consisting of an average, a median, and a standard deviation.

10. The computer system of claim 8, further comprising:
determining a confidence score based on a number of numerical values associated with a concept when determining the similarity distance.

11. The computer system of claim 8, further comprising:
comparing values of two different concepts when the concepts have a same hierarchical parent in a corpus.

12. The computer system of claim 8, further comprising:
updating a real-time value of the distribution value and the distance function as new documents are added to the corpus.

13. The computer system of claim 8, further comprising:
allowing a user to select a standard unit to which the numerical values are converted.

14. The computer system of claim 8, wherein the tolerance value is directly related to a standard deviation of the numerical values.

15. A computer program product for measuring similarity of numeric concept values within a corpus, the computer program product comprising:
one or more computer-readable tangible storage media and program instructions stored on at least one of the one or more tangible storage media, the program instructions executable by a processor of a computer to perform a method, the method comprising:
retrieving numerical values associated with a concept in a corpus;
converting the numerical values to a standard unit;
computing a distribution value of the converted numerical values;
determining a tolerance value based on the distribution value, wherein the tolerance value is the maximum allowable distance between two numerical values;
determining a distance function based on the determined tolerance value, wherein the distance function is defined by dividing a difference between two numerical values by the determined tolerance value; and
computing a similarity distance between the numerical values.

16. The computer program product of claim 15, wherein a distribution value comprises a distribution calculation, wherein the distribution calculation is selected from a group consisting of an average, a median, and a standard deviation.

17. The computer program product of claim 15, further comprising:
determining a confidence score based on a number of numerical values associated with a concept when determining the similarity distance.

18. The computer program product of claim 15, further comprising:
comparing values of two different concepts when the concepts have a same hierarchical parent in a corpus.

19. The computer program product of claim 15, further comprising:
updating a real-time value of the distribution value and the distance function as new documents are added to the corpus.

20. The computer program product of claim 15, wherein the tolerance value is directly related to a standard deviation of the numerical values.
